(19) United States
(12) Patent Application Publication
(10) Pub. No.: US 2010/0298587 A1
(43) Pub. Date: Nov. 25, 2010

(54) PROCESS FOR THE GENTLE REFINING OF VEGETABLE OIL USING NATURAL BLEACHING EARTH

(75) Inventor: Klaus Schurz, Munchen (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: SÜD-CHEMIE AG, Muenchen (DE)

(21) Appl. No.: 12/667,617

(22) PCT Filed: Jul. 3, 2008
(86) PCT No.: PCT/EP2008/005450

§ 371 Date: Jun. 22, 2010

(30) Foreign Application Priority Data
Jul. 4, 2007 (DE) 10 2007 031 039.2

(51) Int. Cl. C11B 3/04

(52) U.S. Cl. 554/191

(57) ABSTRACT

The invention relates to a process for bleaching oils or fats. For this, a naturally active or non-naturally active bleaching earth is provided in a first vessel (10) and an organic acid in a second vessel (11). In a mixing vessel (8), the oil or fat which is to be bleached is admixed with bleaching earth and the organic acid, wherein the bleaching earth and the organic are added individually. Subsequently, the oil or fat which is to be bleached is bleached in a conventional manner.

The invention relates to a process for bleaching oils and fats.

In the industrial production of oils and fats, bleaching earths are used to remove clouding, discolorations or also to remove oxidation accelerators. The taste, colour and storage stability of the oils and fats can be substantially improved by adsorptive purification. Different classes of bleaching earths are used for purification. The class of highly-active, mostly montmorillonite-based bleaching earths (HPBE=High Performance Bleaching Earth) forms a first group. This groups includes in particular acid-activated montmorillonites, wherein the acid activation is carried out in a costly process by dealuminizing the crude clays with concentrated acids at high temperatures, mostly at boiling heat. In this process a bleaching earth product with a very large specific surface and large pore volume is obtained. The use of only small quantities of this highly-active bleaching earth leads to the perceptible purification of the crude oils. Attempts to use small quantities in the bleaching process are worthwhile because, firstly, the bleaching earth used binds to residual quantities of oil, whereby the yield is decreased and, secondly, the bleaching earth used must be disposed of according to the regulations in force.

A disadvantage with these highly-active bleaching earths is that, because of the dealuminization with acid during production, large quantities of acidic salt-rich waste waters form which can be treated or disposed of only in costly processes. The high costs for the disposal of waste and the costly production process are the reason for the comparatively high prices of such highly-active bleaching earths.

The class of naturally active clays (NABE=Natural Active Bleaching Earth) forms a further group. These naturally occurring bleaching earths already have been used for hundreds of years for the purification of fats and oils. These naturally active systems (also called Fuller's earths) can be made available at very favourable cost. However, they possess only a small bleaching power, with the result that they are mostly not suitable for the purification of oils and fats which are difficult to bleach. Furthermore, compared with highly active bleaching earths, substantially larger quantities of the adsorbent must be used in order to achieve the desired bleaching result. Large losses of oil or fat must thereby be accepted, as the bleaching earths cannot be separated in pure form and some quantities of oil or fat remain in the bleaching earth.

A compromise between low production costs and acceptable activity is represented by the third class of bleaching earth, the so-called surface activated systems (SMBE=Surface Modified Bleaching Earth). Here, a naturally active crude clay is subjected to small quantities of acid and an “in situ” activation is thus achieved. Attapulgite- and hormite-containing crude clays in particular have proved themselves successful for this process. These have a very high specific surface area for natural crude clays of approx. 100 to 180 m²/g and a pore volume of approx. 0.2 to 0.35 ml/g. However, as salts formed during the acid activation or non-reacted portions of the acid are not washed out, these remain on the product and are also stored at least in part in the pores. As a result, these acid-activated bleaching earths generally do not achieve the same efficiency as is achieved by highly-active bleaching earths (HPBE) which are produced by dealuminization with acid. However, the simple production process makes possible a comparably cost-favourable production, wherein, as a particular advantage, no acid waste waters form.

In U.S. Pat. No. 5,004,570, a process for the bleaching of oils is described, wherein in a suitable vessel a slurry is produced, which comprises the oil which is to be bleached, a neutral bleaching earth and a chelate-forming polyvalent carboxylic acid. The carboxylic acid has an even number of carboxyl groups, wherein the carboxyl groups are arranged in pairs and the carboxyl groups of each pair can assume an elliptical conformation.

In U.S. Pat. No. 5,151,211 a bleaching-earth composition is claimed which comprises a neutral bleaching earth which includes attapulgite and smectite in a ratio in the range from 0.3:1 to 1.5:1, wherein the proportion of attapulgite and smectite corresponds to at least 65 wt.-% of the bleaching earth. The composition also contains a polyvalent carboxylic acid with an even number of carboxyl groups which are arranged in pairs, wherein the carboxyl groups can each adopt an ecliptic arrangement.

In U.S. Pat. No. 6,346,286 D1 a bleaching-earth composition is claimed which comprises a mixture of a particle-shaped clay and a particle-shaped polyvalent carboxylic acid, wherein the carboxylic acid has a pKₐ value in the range from 1 to 7 and is substantially free from salts of organic acids. The clay has a moisture content of not more than 8 wt.-%, relative to the clay. The polyvalent carboxylic acid is also contained in same in a proportion in the range from 1 to 8 wt.-%, relative to the composition. U.S. Pat. No. 6,346,286 B1 also describes a bleaching process in which the oil which is to be bleached is brought into contact with a particle-shaped composition which comprises particles of a clay mineral and particles of at least one organic acid, wherein the organic acid is substantially free from salts of the organic acid. Citric acid is named among others as a suitable organic acid.

The refining of oils and fats requires in each case a careful selection of the bleaching earth used in order to obtain a satisfactory result. This is true in particular of naturally active and surface-modified bleaching earths. Fats and oils are obtained from natural sources. Therefore, fluctuations between different batches of the same type of oil also occur. In particular in smaller to medium-sized plants, different types of oil are used in the same plant. It would be desirable to be able to match each bleaching earth individually to the crude oil to be purified by adjusting the bleaching earth and its degree of activation in each case to match the oil.

The object of the present invention was therefore to provide a process for the bleaching of oils and fats which makes possible an individual matching of the bleaching earth to the oils and fats which are to be bleached.

This object is achieved in a process with the features of claim 1. Advantageous embodiments of the process according to the invention are the subject of the dependent claims.

In the process according to the invention for bleaching oils and fats:
a naturally active or non-naturally active bleaching earth is provided in a first vessel;
an organic acid is provided in a second vessel;
an oil or fat which is to be bleached is provided in a mixing vessel;
the bleaching earth and the solid organic acid are added individually dispensable to the oil which is to be bleached; and
the oil which is to be bleached is bleached.

Unlike the previously customary procedure, with the process according to the invention the bleaching earth is not sprayed in advance with the acid or ground together with the acid in order to achieve an intimate thorough mixing, but the bleaching earth and the solid organic acid are mixed only immediately before the bleaching process or are added individually dispensable to the oil or fat which is to be bleached. Thereby it becomes possible, firstly, to match the quantity of acid and the quantity of bleaching earth individually to the oil which is to be bleached, with the result that differences between different batches of the same type of oil can also be taken into account. Secondly, several types of bleaching earth can be stored which can then be mixed with a likewise stored solid acid for the bleaching. Thereby, in a plant in which different oils are refined, the bleaching earths used can be individually matched by selecting a suitable bleaching earth in each case and then admixing this with the likewise separately stored, preferably solid, organic acid. This is advantageous in particular, from the cost aspect, for plants which process changing types of oils.

Naturally active or non-naturally active bleaching earths can be used as bleaching earths. By naturally active or non-naturally active bleaching earth is meant, within the meaning of the invention, a bleaching earth which has not yet undergone any activation steps, in particular has not yet been subjected to an acid. The bleaching earth can already have a certain activity even without added acid during the bleaching of oils and fats, wherein this bleaching effect can, however, be further enhanced by the addition of an organic acid. These naturally active or non-naturally active bleaching earths are obtained usually from natural sources, i.e. extracted from a mine. They are then dried and ground. The naturally active or non-naturally active bleaching earth provided in the process according to the invention is prepared in a conventional manner, i.e. it has a customary moisture and a customary fineness. The moisture of the bleaching earth is usually set at a water content in the range from 5 to 50 wt.-%, preferably 10 to 30 wt.-%. The grain size of the bleaching earth is usually set such that the residue lies on a sieve with a mesh width of 63 μm in the range from approximately 5 to 45 wt.-%, preferably 20 to 40 wt.-%. The average particle diameter d₅₀ preferably lies in the range from 15 to 45 μm, preferably 20 to 40 μm, particularly preferably 25 to 35 μm. The naturally active or non-naturally active bleaching earth is preferably provided in a form in which it is free-flowing and can flow out from the first vessel under the action of gravity without a corresponding conveyor being required.

The organic acid is provided in a second vessel. The organic acid can be provided in dissolved form, preferably as an aqueous solution, or else as a solid powder. Here also the organic acid is preferably provided in a form in which it can flow out automatically of the second vessel under the action of gravity.

In particular if the bleached oils are used as food, acids which are approved for food use are preferably used as organic acids. In particular, organic acids are preferably used which are solid at room temperature. The organic acids preferably have at least two carboxyl groups. Examples of organic acids which are preferably solid at room temperature are citric acid, oxalic acid or else tartaric acid. The use of citric acid is particularly preferred.

The oil or fat which is to be bleached is provided in a mixing vessel. This mixing vessel can be a receiver in which the oil or fat which is to be bleached is mixed with the naturally active or non-naturally active bleaching earth and the organic acid in order then to be transferred into a bleaching tank. The mixing vessel can, however, also be designed such that after the addition of the naturally active or non-naturally active bleaching earth and the organic acid the oil or fat can be bleached directly in the mixing vessel. Customary vessels can be used as mixing vessels. These mixing vessels are preferably equipped with a mixing device, for example in the form of a stirrer. However, for example a steam inlet can also act as a mixer, with which superheated steam is introduced into the oil mixed with the bleaching earth and the organic acid.

The naturally active or non-naturally active bleaching earth and the organic acid are then added individually dispensable to the oil which is to be bleached. For this, according to one embodiment the first vessel can be provided with a first actuatable dosing device and the second vessel with a second actuatable dosing device, which can each be actuated individually. The dosing can for example take place by providing a corresponding valve on the first vessel or on the second vessel by which the quantity of the naturally active or non-naturally active bleaching earth removed from the first vessel and the quantity of the organic acid removed from the second vessel can be quantitatively regulated. However, a special conveyor can be also be provided, for example in the case of solid starting substances a conveying screw or in the case of liquid starting substances a pump, with which the quantity flow of the added bleaching earth and the organic acid can be regulated. After the addition of the bleaching earth and the organic acid the oil or fat which is to be bleached is bleached. Customary parameters are observed for this purpose. After the addition of the bleaching earth and organic acid the oil is heated, for example at normal pressure, preferably to 60 to 100° C., preferably 70 to 95° C., particularly preferably 80 to 90° C. and stirred for a period of 10 to 40 minutes, preferably 15 to 25 minutes. The treatment time depends on the oil or fat to be treated and can be ascertained individually for example by sampling during bleaching. A vacuum is then applied (for example 30 to 150 mbar, preferably 60 to 100 mbar) and the oil stirred for approximately 10 to 60 minutes, preferably 20 to 40 minutes at approximately 80 to 140° C., preferably 90 to 120° C. The bleaching earth is then separated, for example by filtering the oil over a nutsch filter coated with a paper filter. Filtration is preferably carried out at an increased temperature, preferably in the range from 60 to 90° C., particularly preferably 70 to 85° C.

With the process according to the invention the quantity of organic acid added can be individually matched to the oil which is to be bleached and to the naturally active or non-naturally active bleaching earth used. The suitable quantity can be determined by a person skilled in the art by corresponding preliminary tests. The proportion of organic acid relative to the weight of the naturally active or non-naturally active bleaching earth is preferably chosen in a range from 0.1 to 10 wt.-%, preferably 1 to 5 wt.-%, particularly preferably 2 to 4 wt.-%.

The proportion of naturally active or non-naturally active bleaching earth which is added during bleaching depends on the oil which is to be bleached. The suitable quantity can be determined by preliminary tests. Relative to the weight of the oil which is to be bleached, the quantity of the bleaching earth added is preferably chosen in the range from 0.01 to 10 wt.-%, preferably 0.1 to 5 wt.-%, particularly preferably 0.5 to 3 wt.-%. According to a preferred embodiment the organic acid is provided in solid form. If the acid is in solid form, experience shows that it is stable even during prolonged storage, with the result that no reductions in quality need be accepted. Also, a solid powder can be very well dispensed, for example via a conveying screw. As a further advantage organic acids are less aggressive if present in solid form, i.e. the corrosion on the reservoirs occurs only to a small extent or more favourable materials can be used to produce the reservoirs.

As already stated above, the solid organic acid should be able to flow out of the reservoir under the action of gravity. Surprisingly it was found that with specific organic acids such as in particular citric acid a bridging commences if the organic acid is stocked in pure form. The solid organic acid is therefore preferably mixed with a suitable flow improver. Flow improvers which are approved for food use are preferred as flow improvers. For example, silicon dioxide, diatomaceous earth or even talcum are suitable.

A clay mineral is preferably used as flow improver, particularly preferably a naturally active or non-naturally active bleaching earth.

The flow improver is added in a quantity from 5 to 30 wt.-% relative to the solid organic acid. If smaller quantities of flow improver are added, bridging in the reservoir cannot reliably be suppressed. If larger quantities of flow improver are used the quantity of the added solid also increases, which is disadvantageous in particular if the flow improver involved does not simultaneously also have a bleaching effect on the oil or fat to be treated. The quantity of flow improver is preferably chosen in a range from 6 to 25 wt.-%, particularly preferably 7 to 15 wt.-%.

The addition of the bleaching earth and the organic acid to the oil or fat which is to be bleached can take place in different ways.

According to a first embodiment, the organic acid and the naturally active or non-naturally active bleaching earth are introduced separately to the mixing vessel, there to be admixed with the oil or fat. In this case, the organic acid can also be added in the form of an aqueous solution. This is advantageous in particular if an aqueous solution of the organic acid is also used for other process steps, such as for example a degumming of the oil. In this case, only a single reservoir is then required.

According to a further embodiment, the bleaching earth and the solid organic acid are admixed with a bleaching mixture immediately before being added to the oil or fat which is to be bleached. For this, the naturally active or non-naturally active bleaching earth and the solid organic acid are removed from the reservoirs in the desired quantities and admixed intensively via a mixing device. The obtained bleaching mixture is then added to the oil or fat which is to be bleached.

A conveying screw is preferably used as mixing device. The bleaching earth and the solid organic acid are fed to conveying screw. An intimate thorough mixing of bleaching earth and organic acid then takes place in the conveying screw.

In order to achieve an intimate thorough mixing the solid organic acid preferably has an average particle size D₅₀ in the range from 20 to 40 μm.

According to a preferred embodiment of the process the oil or fat which is to be bleached is degummed, prior to the addition of the bleaching earth and the organic acid, to a phosphorous content of less than 15 ppm.

The process according to the invention is further explained below with the help of examples and a figure. There is shown in

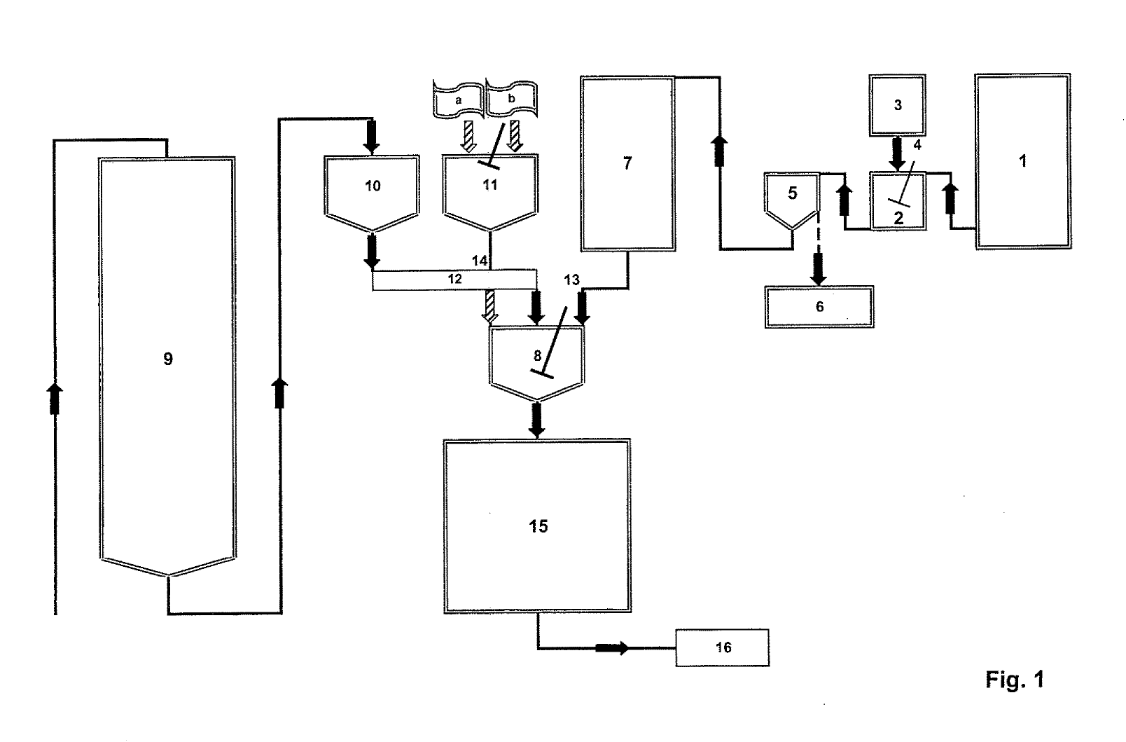

FIG. 1: a schematic representation of a device such as can be used to carry out the process according to the invention.

FIG. 1 shows schematically a device for carrying out the process according to the invention. The crude oil, which has been produced for example by pressing suitable plant seeds in an oil mill, is first subjected to a drying and degassing stage (not represented), in order to remove for example dissolved oxygen from the oil. The degassed crude oil, which has a phosphorous content in the region of approximately 250 ppm, is then stocked in a crude oil tank 1. The crude oil is firstly fed to a degumming step. For this, the crude oil from the crude oil tank 1 is fed to a degumming vessel 2. In the degumming step, mucilaginous substances, in particular phospholipids, are separated off. The degumming can include a preliminary degumming and an acid degumming. During the preliminary degumming, water is added to the crude oil and the mixture stirred at 70 to 80° C. at normal pressure. The aqueous lecithin phase is then separated off. After the preliminary degumming the crude oil has a phosphorous content in the range from approximately 100 to 200 ppm. With the acid degumming shown in FIG. 1 the preliminary degummed oil is added to an acid in the degumming vessel 2. A 50% citric acid which is removed from an acid reservoir 3 can be used as acid for example. The degumming vessel 2 is provided with a stirrer 4 which makes possible an intensive mixing of acid and crude oil. The crude oil added to the acid is heated in the degumming vessel 2 to approximately 70 to 100° C. and then stirred at normal temperature. Exemplary conditions are an acid quantity of 0.06 wt.-% of a 50% citric acid, a treatment temperature of approximately 95° C. and a treatment period of approximately 15 minutes. At the end of the acid degumming more water can be added, wherein the chosen water quantity is approximately 0.2 wt.-%, in order to facilitate the separation of mucilaginous substances. To separate off the aqueous phase, the mixture is transferred into a centrifuge 5 in which the aqueous phase which contains the mucilaginous substances is separated from the degummed crude oil. The mucilaginous substances are collected in a vessel 6. After the acid degumming the oil has a phosphorous content in the range from approximately 10 to 20 ppm. The degumming is necessary in order, in combination with the following bleaching, to reduce the proportion of the phospholipids (mucilaginous substances) contained in the oil and of the metals. If degumming is dispensed with, the phosphorous and iron contents are often too high, even when there are sufficiently low Lovibond red/yellow colour indexes in the refined oil. After degumming the oil can optionally be dried and degassed (not represented). For low-phosphorous oils, such as e.g. palm oil, the acid degumming can optionally be dispensed with and the bleaching carried out directly. The degummed oil is first collected in a reservoir tank 7 for degummed oil.

Degumming is followed by a bleaching of the oil, wherein firstly a wet bleaching and then a vacuum bleaching can be carried out. For this, the degummed oil is transferred from the reservoir tank 7 into a mixing tank 8. In the mixing tank 8 the degummed oil is added to the bleaching earth and the citric acid. For this, bleaching earth which is stocked in a bleaching earth silo 9 is transferred into a first receiver 10. In a second receiver 11 powdered citric acid (a) is stocked which is mixed with a flow improver (b), for example a naturally active or non-naturally active bleaching earth. The bleaching earth is fed from the first receiver 10 to a conveying screw 12. The solid citric acid and the flow improver are also fed to the conveying screw 12 from the second receiver 11 with the result that the components are mixed in the conveying screw 12. The bleaching mixture is then fed to the mixing tank 8 where it is intensively mixed with the degummed oil with the help of the stirrer 13. It is not necessary for the citric acid in the conveying screw to be mixed with the bleaching earth. According to a further embodiment, the bleaching earth can merely be transferred with the conveying screw 12 into the mixing tank 8 and, separately from this the citric acid from the second receiver introduced directly into the mixing tank. A conveyor 14 is provided for this, via which the citric acid is transferred directly into the mixing tank 8. The degummed oil, with the added bleaching earth and the citric acid, then passes from the mixing tank 8 into a bleacher 15. In the bleacher 15, the oil is first heated at normal pressure to approximately 80 to 100° C. and then stirred for approximately 20 minutes. A vacuum (for example 100 mbar) is then applied and the oil stirred for a further 30 minutes at approximately 90 to 120° C. The oil is then fed to a filter 16 in which the used bleaching earth is separated from the bleached oil. A nutsch filter coated with a filter paper can be used as filter for example. Filtration is carried out at a temperature of approximately 80° C.

After bleaching the oil can also be deodorized. Deodorization is not shown in FIG. 1. Superheated steam which has an outlet temperature of approximately 240 to 260° C. is passed through the oil for deodorization, in order to remove free fatty acids and unpleasant taste-causing and odoriferous substances. Deodorization is carried out under a vacuum at a pressure in the range below 5 mbar, preferably 1 to 3 mbar.

After refining the oil has a phosphorous content of less than 3 ppm and an iron content of less than 0.1 ppm.

### EXAMPLE 1

### Refining of Rape-Seed Oil

0.75 wt.-% of the bleaching agents listed in Table 1 is added to a degummed rape-seed oil and bleaching then carried out for 30 minutes at 105° C., wherein a reduced pressure of 60 mbar was applied. For deodorizing, hot steam which had an outlet temperature of 235° C. was conducted through the mixture at a reduced pressure of less than 1 mbar for 60 minutes. The still-hot oil is then filtered through a paper filter in order to separate off solids from the oil. The properties of the refined oils are summarized in Table 1.

TABLE 1
refining of degummed rape-seed oil with different bleaching agents

| | | | Lov. | | PON | | | | | | | | Lov. | | | | | |
|---|---|---|---|---|---|---|---|---|---|---|---|---|---|---|---|---|---|---|
| | | | red | Chl.A | meq | | P | Fe | Ca | Mg | | | red | Chl.A | | | | |
| | Bleaching earth | | 5¼″ | ppm | O₂/g | ANN | ppm | ppm | ppm | ppm | E₂₃₂ | E₂₇₀ | 5¼″ | ppm | ANN | E₂₃₂ | E₂₇₀ | IP |
| V1 | Crude oil | | 5.7* | 3.60 | 3.0 | 2.4 | 15.0 | 0.3 | 6.7 | 1.2 | 1.98 | 0.38 | — | — | — | — | — | — |
| V2 | Supreme ® 110 FF | | 2.5 | 0.04 | — | 2.7 | 4.5 | 0.11 | 3.3 | 0.4 | 2.08 | 0.41 | 1.2 | 0.04 | 1.5 | 3.07 | 0.40 | 10.6 |
| V3 | Optimum ® 214 FF | | 3.0 | 0.05 | — | 2.6 | 4.0 | 0.10 | 3.2 | 0.4 | 2.00 | 0.39 | 1.3 | 0.04 | 1.4 | 3.02 | 0.40 | 10.8 |
| V4 | Optimum ® 210 FF | | 4.7 | 0.09 | — | 2.8 | 5.3 | 0.10 | 3.9 | 0.5 | 1.99 | 0.40 | 1.7 | 0.09 | 1.4 | 2.98 | 0.40 | 10.4 |
| V5 | Supreme ® 112 FF | | 4.2 | 0.05 | — | 3.0 | 1.9 | <0.1 | 1.5 | 0.2 | 2.11 | 0.46 | 1.1 | 0.05 | 1.5 | 3.13 | 0.44 | 10.3 |
| E1 | EX 1221 | a | 14.0 | 0.09 | — | 2.8 | 0.9 | <0.1 | 1.2 | 0.2 | 2.02 | 0.46 | 1.2 | 0.08 | 1.6 | 2.95 | 0.37 | 8.2 |
| | (I)/H₃Cit (3%) | | | | | | | | | | | | | | | | | |
| E2 | EX 1221 (I)/ | b | 14.2 | 0.09 | — | 2.8 | 0.8 | <0.1 | 1.0 | 0.1 | 1.97 | 0.46 | 1.0 | 0.08 | 1.6 | 2.98 | 0.38 | 10.6 |
| | H₃Cit (3%) | | | | | | | | | | | | | | | | | |
| E3 | EX 1221 (I)/ | c | 18.7 | 0.11 | — | 2.4 | 1.8 | <0.1 | 2.0 | 0.3 | 1.89 | 0.45 | 1.1 | 0.09 | 1.6 | 2.84 | 0.35 | 10.2 |
| | H₃Cit (3%) | | | | | | | | | | | | | | | | | |
| E4 | EX 1221 (I)/ | d | >20 | 0.13 | — | 2.3 | 1.8 | <0.1 | 2.0 | 0.3 | 1.88 | 0.45 | 1.2 | 0.10 | 1.6 | 2.86 | 0.34 | 9.7 |
| | H₃Cit (3%) | | | | | | | | | | | | | | | | | |

In the comparison examples V1 to V5 the following commercially available bleaching earths were used:

Supreme®110 FF, Supreme® 112 FF, Optimum®214 FF, Optimum®210 FF; manufacturer: Süd-Chemie AG, Munich, DE

For the examples according to the invention E1 to E4 the following naturally active bleaching earth (NABE) was used:

EX 1221 (I); manufacturer: Süd-Chemie AG, Munich, DE

The following addition processes were used for the bleaching according to the invention (E1 to E4):
a: addition of a mixture of EX 1221 (I) and citric acid (E1);
b: separate simultaneous addition of EX 1221 (I) and citric acid (E2);
c: addition of an aqueous citric acid solution (50%) followed by addition of EX 1221 (I)(E3);
d: addition of EX 1221 (I) followed by addition of an aqueous citric acid solution (50%) (E4);

The parameters reproduced in Table 1 were determined according to the following methods:

Lovibond red colour index: The Lovibond red colour index was measured in a 5′4″ vessel (or in the case of crude oil (*) in a 1″ vessel) according to AOCS Cc 13b-45.

Chlorophyll A: Chlorophyll A was determined according to AOCS Cc 13d-55.

Peroxide number (PON): The peroxide number was determined with the DGF method F-I 3b.

Induction period (IP): To measure the induction period in each case the Rancimat test (Rancimat 743, Metrohm) was carried out. For this, a constant air stream was passed through the heated sample and collected in a measuring vessel filled with distilled water. During oxidation short-chain organic acids, in particular formic acid, form which dissolve in the distilled water of the measuring vessel. The conductivity of the distilled water was measured in relation to time. The conductivity remains constant at first and then rises. A tangent was applied to the rising branch of the curve and the induction time read off on the x axis.

Anisidine number (ANN): This was determined according to C-VI 6e (77)

E₂₃₂: Absorbance at 232 nm was measured in a 1% solution in hexane. It is a measure of the number of conjugated double bonds which are produced by the decomposition of peroxides. It is therefore a criterion for oxidative pre-loading of the oil.

E₂₇₀: Absorbance at 270 nm was measured in a 1% solution in hexane. It is a measure of the number of conjugated triple bonds and therefore reflects the oxidative pre-loading of the oil.

P, Fe, Ca, Mg: The elements were determined by ICP according to DEV E-22.

### EXAMPLE 2

### Determining the Flow Properties

The following test set-up is used to ascertain the vertical flow properties of citric acid or natural earth powder or mixtures relative to one another:

Citric acid (H₃Cit) is intimately mixed with natural bleaching earth (NABE) in the ratios
95:5
90:10
85:15
80:20
75:25
70:30

The total quantity is 100 g. The educts and the prepared mixtures are transferred in each case into a powder funnel which is sealed at the bottom with a watch glass. The diameter of the powder funnel is 2.8 cm, the height is 14 cm. After removal of the watch glass it is observed—initially without any further exposure to mechanical action—whether the material flows very well to well (rating “++ to +”). If this is not the case, an attempt is made to bring about an outflow by (very) light tapping with a spatula (if yes, rating “x to o”). If there is no flow capability even then, the rating is “−”).

The results are summarized in Table 2:

TABLE 2
flow properties of mixtures of citric acid and
flow improvers

Mixture (%)

| H₃Cit | NABE | Assessment |
|---|---|---|
| 100 | 0 | − |
| 95 | 5 | ◯ |
| 90 | 10 | X |
| 85 | 15 | + |
| 80 | 20 | ++ |
| 75 | 25 | ++ |
| 70 | 30 | ++ |
| 0 | 100 | ++ |

### LIST OF REFERENCE NUMBERS

1. First crude oil tank
2. Degumming vessel
3. Acid reservoir
4. Stirrer
5. Centrifuge
6. Waste vessel
7. Reservoir tank for degummed oil
8. Mixing tank
9. Bleaching earth silo
10. First receiver
11. Second receiver
12. Conveying screw
13. Stirrer
14. Conveyor
15. Bleacher
16. Filter

1. Process for bleaching oils and fats, wherein:
a naturally active or non-naturally active bleaching earth is provided in a first vessel (10);
an organic acid is provided in a second vessel (11);
an oil or fat which is to be bleached is provided in a mixing vessel (8);
the bleaching earth and the organic acid are added individually dispensable to the oil which is to be bleached; and
the oil or fat which is to be bleached is bleached.

2. Process according to claim 1, wherein the organic acid is provided in solid form.

3. Process according to claim 1, wherein the organic acid is citric acid.

4. Process according to claim 2, wherein the solid organic acid has an average particle size D₅₀ in the range from 20 to 40 μm.

5. Process according to claim 2, wherein a flow improver is added to the solid organic acid.

6. Process according to claim 5, wherein the flow improver is a naturally active bleaching earth.

7. Process according to claim 5, wherein the flow improver is contained in a quantity from 5 to 30 wt.-% relative to the solid organic acid.

8. Process according to claim 2, wherein the bleaching earth and the solid organic acid are mixed to produce a bleaching mixture before being added to the oil or fat which is to be bleached.

9. Process according to claim 8, wherein the solid organic acid and the bleaching earth are mixed in a conveying screw.

10. Process according to claim 1, wherein the oil or fat has been degummed to a phosphorous content of less than 15 ppm, prior to the addition of the bleaching earth and the organic acid.

11. Process according to claim 2, wherein the organic acid is citric acid.

12. Process according to claim 3, wherein the solid organic acid has an average particle size D₅₀ in the range from 20 to 40 μm.

13. Process according to claim 3, wherein a flow improver is added to the solid organic acid.

14. Process according to claim 4, wherein a flow improver is added to the solid organic acid.

15. Process according to claim 6, wherein the flow improver is contained in a quantity from 5 to 30 wt.-% relative to the solid organic acid.

16. Process according to claim 3, wherein the bleaching earth and the solid organic acid are mixed to produce a bleaching mixture before being added to the oil or fat which is to be bleached.

17. Process according to claim 4, wherein the bleaching earth and the solid organic acid are mixed to produce a bleaching mixture before being added to the oil or fat which is to be bleached.

18. Process according to claim 5, wherein the bleaching earth and the solid organic acid are mixed to produce a bleaching mixture before being added to the oil or fat which is to be bleached.

19. Process according to claim 6, wherein the bleaching earth and the solid organic acid are mixed to produce a bleaching mixture before being added to the oil or fat which is to be bleached.

20. Process according to claim 7, wherein the bleaching earth and the solid organic acid are mixed to produce a bleaching mixture before being added to the oil or fat which is to be bleached.
